(19) United States
(12) Patent Application Publication
(10) Pub. No.: US 2013/0104715 A1
(43) Pub. Date: May 2, 2013

(54) Debris Collection Device for Cutting Mechanism, LCD Panel Cutting Debris Suction Device

(71) Applicants: Junjie Huang, Guangdong (CN); Hongqing Huang, Guangdong (CN); Weiwei Zhang, Guangdong (CN); Rui Xu, Guangdong (CN); Huifang Duan, Guangdong (CN); Jungmao Tsai, Guangdong (CN); Yizhuang Zhuang, Guangdong (CN); Xiaoxin Zhang, Guangdong (CN)

(72) Inventors: Junjie Huang, Guangdong (CN); Hongqing Huang, Guangdong (CN); Weiwei Zhang, Guangdong (CN); Rui Xu, Guangdong (CN); Huifang Duan, Guangdong (CN); Jungmao Tsai, Guangdong (CN); Yizhuang Zhuang, Guangdong (CN); Xiaoxin Zhang, Guangdong (CN)

(21) Appl. No.: 13/375,524

(22) PCT Filed: Nov. 3, 2011
(86) PCT No.: PCT/CN2011/081764

§ 371 Date: Dec. 1, 2011

(30) Foreign Application Priority Data
Oct. 28, 2011 (CN) 201110335052.0

(51) Int. Cl. B26D 7/18

(52) U.S. Cl. 83/100; 83/98

(57) ABSTRACT

The present invention discloses a debris collection device for cutting mechanism and an LCD panel cutting debris suction device. A debris collection device for cutting mechanism, wherein the debris collection device comprises a collection cap positioned behind the traveling direction of the cutting mechanism, and an air spray head positioned in front of the traveling direction of the cutting mechanism. The present invention can clear the debris produced in the LCD panel cutting process in time, and can reduce relevant defects such as line scratches, terminal scratches, short circuit, broken circuit, etc. which are generated because of debris. Thus, the yield and quality of products can be improved; the time of the subsequent cleaning process can be reduced; and the purposes of reducing risk, improving product yield and saving production cost can be achieved.

### TECHNICAL FIELD

The present invention relates to the field of liquid crystal displays (LCDs), and more particularly to a debris collection device for cutting mechanism and an LCD panel cutting debris suction device.

### BACKGROUND

At present, in the field of thin film transistor liquid crystal displays (TFT-LCDs), the TFT-LCD panel process is divided into an Array process, a Cell process and an LCM process. Wherein, in the Cell process, the glass of the Array process is mainly used as a substrate; the substrate is bonded to a color filter (CF); liquid crystal is filled between the glass substrates; and the bonded glass substrate is cut into required size. In the process of cutting an LCD panel, glass debris is produced because of the contact between a cutting wheel and the glass; if the debris cannot be completely cleared in time, the panel is damaged, and the product yield is reduced. As shown in FIG. 1, FIG. 1 is a structure diagram of a glass cutting machine in the Cell process. The existing glass cutting machine does not do any treatment in the cutting process, so that the corresponding glass debris is kept and is cleaned in the next station. The treating mode causes the following results:

1. The subsequent cleaning time is increased, and the increase of the production capacity is affected;

2. The problems of line scratches, terminal scratches, short circuit, broken circuit, etc. of the LCD panel are caused by glass debris;

3. The lung of a person is injured when glass debris is inhaled by the person, and lung cancer is caused if glass debris is inhaled for a long time;

4. Bad products are easily caused if foreign matter such as glass debris, etc. fall into workpieces; and

5. The processing machine is easily seized or is rapidly worn if foreign matter such as glass debris, etc. falls into the machine.

To solve the problem of glass debris, the prior art provides a technical scheme as shown in FIG. 2. The technical scheme is: a sucking disk is arranged behind the traveling direction of a cutting wheel to adsorb the produced glass debris, and then glass debris is adsorbed in the cutting process in time. However, because glass debris is dispersed around the cutting wheel, the technical scheme can only adsorb partial glass debris behind the traveling direction of the cutting wheel, but cannot adsorb glass debris in other directions.

A Chinese patent CN201241007Y discloses an LCD panel cutting debris collection device. As shown in FIG. 3, the glass cutting machine comprises a cutting mechanism 100, a positioning mechanism 200 and a cutting wheel 300. The cutting wheel 300 is arranged on a head part of the cutting mechanism 100 and is fixed on the cutting mechanism 100 by bolts and the like; and glass is levelly cut by the cutting wheel 300 at high speed. The positioning mechanism 200 is positioned under the cutting wheel 300, and is used as a workbench for fixing the glass to be cut.

The core of the technical scheme is that the glass cutting machine also comprises an injection device, and the injection device comprises an injection source mechanism 400 and a number of discharge pipes 500. The discharge pipes 500 are made of plastic or metal, and are arranged around the cutting mechanism 100; one end of each discharge pipe 500 is connected to an injection source mechanism, and the other end is connected to a spray head. The spray head is just aligned with the position of the cut glass, and can spray water or mist into the discharge pipes 500. Therefore, when the cutting wheel 300 cuts glass, the effect of cleaning foreign matter in the cutting path can be achieved by spraying water or mist to the cutting position; and more importantly, glass debris can be prevented from flying to damage the machine, products and human bodies. The technical scheme can prevent the damage caused by flying glass debris. However, spraying water or mist can only flush the glass debris from the machining area of the cutting wheel, and the glass debris flows with the water flow everywhere and falls on the glass surface. Thus, the problems of line scratches, terminal scratches, short circuit, broken circuit, etc. of an LCD panel are still caused; in addition, the machined LCD panel is still required to be further cleaned, and then the increase of the production capacity is affected.

### SUMMARY

The aim of the present invention is to provide a debris collection device for cutting mechanism capable of efficiently collecting cutting debris, in particular LCD panel cutting glass debris, and an LCD panel cutting debris suction device.

The purpose of the present invention is achieved by the following technical schemes.

A debris collection device for cutting mechanism comprises a collection cap positioned behind the traveling direction of the cutting mechanism, and an air spray head positioned in front of the traveling direction of the cutting mechanism.

Preferably, groove(s) is arranged in the debris collection cap. The groove can prevent the collected debris from falling onto the workpiece surface again because of self-weight and collision.

Preferably, an opening of the collection cap opposite to the cutting mechanism is inwards concave, and the width of the opening is more than the thickness of the cutting mechanism. The opening has large width and is inwards concave, and covers part of the cutting mechanism or even the whole cutting mechanism. Thus, the collection range of the collection cap is expanded, and the cutting debris is cleanly sucked to the maximum extent.

Preferably, the opening is semicircular in shape. This is a specific structure form of the opening which has large width and is inwards concave.

Preferably, the debris collection device for cutting mechanism comprises multiple debris collection caps of different sizes; the debris collection caps are replaced in accordance with the movement limitation of the cutting mechanism or the space of the original cutting machine, and the application range of the device is expanded.

Preferably, the debris collection device for cutting mechanism also comprises a debris adsorption tube capable of adsorbing cutting debris, and the collection cap is connected with a suction device by the adsorption tube. Because of space limitation, the debris collection cap is short and small, and the time of airflow passing through the debris collection cap is short, and the cutting debris collection effect is limited; because the debris adsorption tube is thin and long, and there is sufficient time for airflow to separate from debris in the adsorption tube, the cutting debris collection capacity of the debris collection cap is further increased.

Preferably, the debris collection device for cutting mechanism also comprises a blow pipe, and the air spray head is connected with the air supply device by the blow pipe. By being connected by the blow pipe, the air spray head is made to be short and small, and the mobility of the device is increased.

Preferably, the debris collection device for cutting mechanism also comprises a fixing device for fixing the cutting mechanism; and the fixing device comprises a spray head fixer for fixing the air spray head and a collection cap fixer for fixing the collection cap. The cutting mechanism, the air spray head and the collection cap are simultaneously fixed by the fixing device so that the three equipment can move simultaneously, and the operation difficulty is simplified.

Preferably, the spray head fixer can be horizontally moved on the fixing device, and the length of the spray head fixer can be adjusted. The technical scheme can adjust the relative height and the relative distance of the air spray head and the cutting mechanism so as to adjust the sweeping effect.

Preferably, the collection cap fixer can be horizontally moved on the fixing device, and the length of the collection cap fixer can be adjusted. The technical scheme can adjust the relative height and the relative distance of the collection cap and the cutting mechanism so as to adjust the collection range of the cutting debris.

Preferably, the airflow speed of the air supply device can be adjusted. The technical scheme can adjust the jet airflow in accordance with the field use situation so as to achieve the preferable cutting debris suction effect.

Preferably, the air suction capacity of the suction device is more than the air discharge capacity of the air supply device so that the phenomenon that debris cannot be completely cleared because of unsmooth airflow is avoided.

Preferably, the cutting mechanism comprises a cutting wheel; the debris collection device for cutting mechanism is provided with a collection cap connected with the suction device behind the traveling direction of the cutting wheel, and is provided with an air spray head connected with the air supply device in front of the traveling direction of the cutting wheel. This is a debris collection device for cutting mechanism which is applicable to the LCD cutting field, and can collect cutting debris.

Preferably, the horizontal positions of the air spray head and the collection cap are higher than the position of the lower edge of the cutting wheel so that scratches caused by directly contacting the workpiece surface are avoided.

Preferably, the collection cap is made of non-conductive material instead of conductive material such as metal, conductive plastic and the like; this minimize the risk of wire short circuit because of the additional friction-produced and collision-produced metal debris remaining on the workpiece surface.

An LCD panel cutting debris suction device comprises a collection cap positioned behind the traveling direction of the cutting wheel of the LCD cutting mechanism, and an air spray head positioned in front of the traveling direction of the cutting wheel.

The present invention is provided with a collection cap behind the traveling direction of the cutting mechanism, and an air spray head in front of the traveling direction of the cutting mechanism; the air spray head is connected with an air supply device, and the collection cap is connected with a suction device. In the process of cutting workpiece of the cutting mechanism, the air spray head positioned in front of the cutting mechanism ejects blowing airflow; the blowing airflow blows the cutting debris in front of the cutting mechanism and on both sides of the cutting mechanism to the back part of the traveling direction of the cutting mechanism; the collection cap positioned behind the traveling direction of the cutting mechanism produces absorption airflow under the action of the suction device, and the absorption airflow carries the cutting debris behind the traveling direction of the cutting mechanism and the cutting debris blown by the blowing airflow to enter the collection cap together. Thereafter, the cutting debris is separated from air in the collection cap, and the cutting debris is kept in the collection cap. Compared with the simple rear suction, the technical scheme of the present invention has the advantages that the cutting debris produced in all directions in the cutting process is sucked, and the cutting debris is thoroughly cleared; compared with the water spray or mist spray cutting device, the technical scheme of the present invention has the advantages that the cleared cutting debris is collected in the collection cap together instead of being left on the LCD panel; the problems such as line scratches, terminal scratches, short circuit, broken circuit, etc. of the LCD panel which are caused by cutting debris are effectively reduced; the subsequent LCD panel cleaning time is saved; the subsequent cleaning process is even cancelled; the productivity is increased; and the production capability is expanded. In a word, the present invention can clear the debris produced in the cutting process in time, and can reduce relevant defects which are generated because of debris; and more particularly in the LCD cutting field, it can avoid the defects such as LCD panel line scratches, terminal scratches, short circuit, broken circuit, etc. Thus, the product yield and quality can be improved; the time of the subsequent cleaning process can be reduced; and the purposes of reducing risk, improving product yield and saving production cost can be achieved.

### BRIEF DESCRIPTION OF FIGURES

FIG. 1 is a schematic diagram of one existing LCD panel cutting debris collection device;

FIG. 2 is a schematic diagram of the other existing LCD panel cutting debris collection device;

FIG. 3 is a schematic diagram of an LCD panel cutting debris collection device of a contrast document;

FIG. 4 is a schematic diagram of a debris collection device for cutting mechanism of the present invention; and

FIG. 5 is a top view of a debris collection device for cutting mechanism of the present invention.

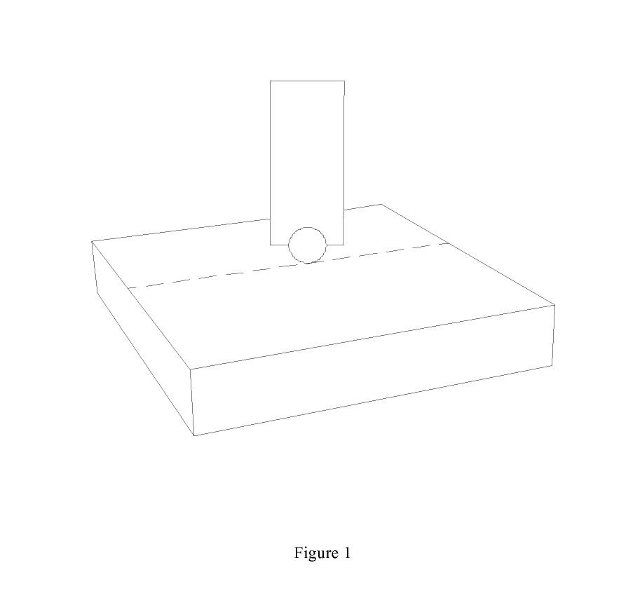

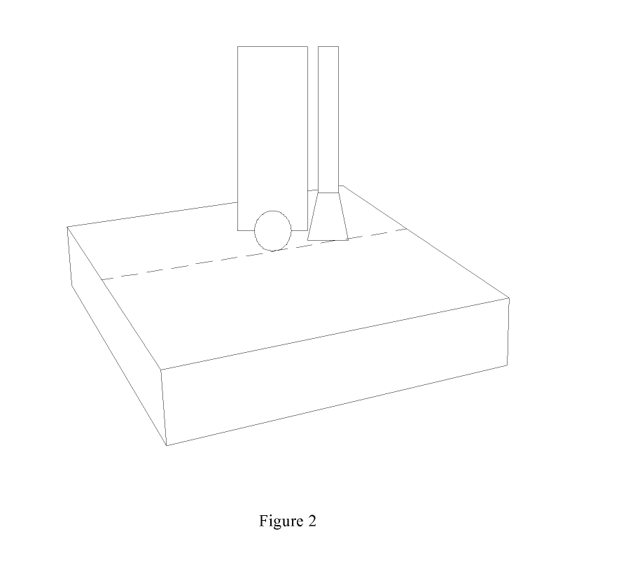

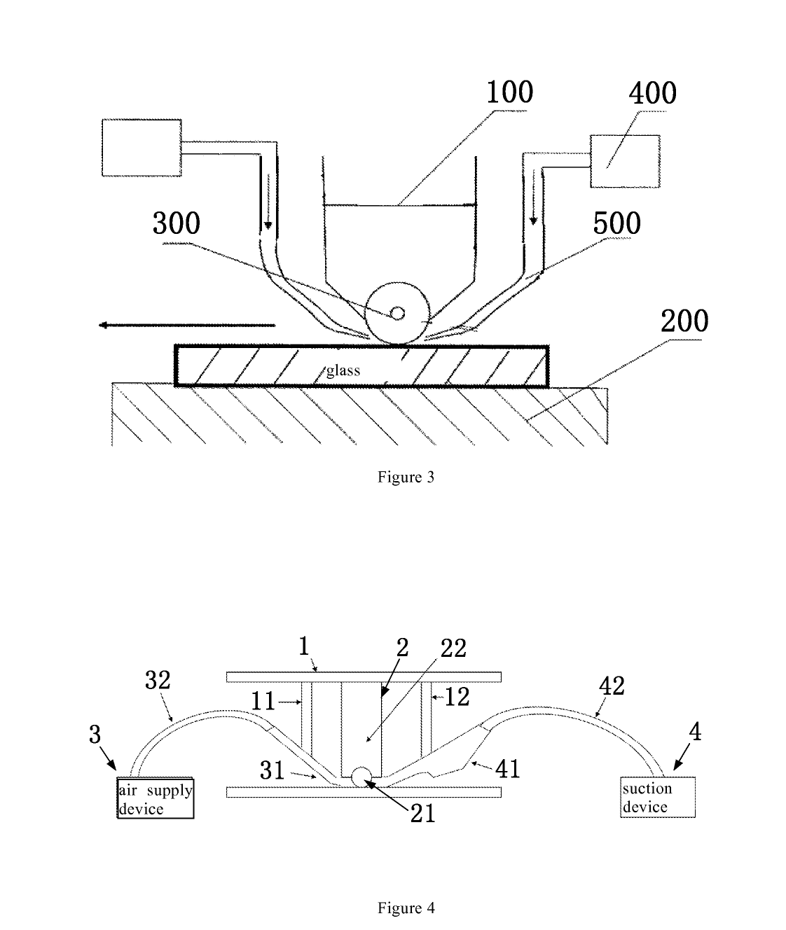

Wherein: 1. fixing device; 11. spray head fixer; 12. collection cap fixer; 2. cutting mechanism; 21. cutting wheel; 22. cutting wheel fixing device; 3. air supply device; 31. air spray head; 32. blow pipe; 4. suction device; 41. collection cap; 42. adsorption tube.

### DETAILED DESCRIPTION

The present invention will further be described in detail in accordance with the figures and the preferred embodiments.

A debris collection device for cutting mechanism comprises a collection cap positioned behind the traveling direction of the cutting mechanism, and an air spray head positioned in front of the traveling direction of the cutting mechanism. The invention will further be described in detail by using an LCD panel cutting debris suction device as an example.

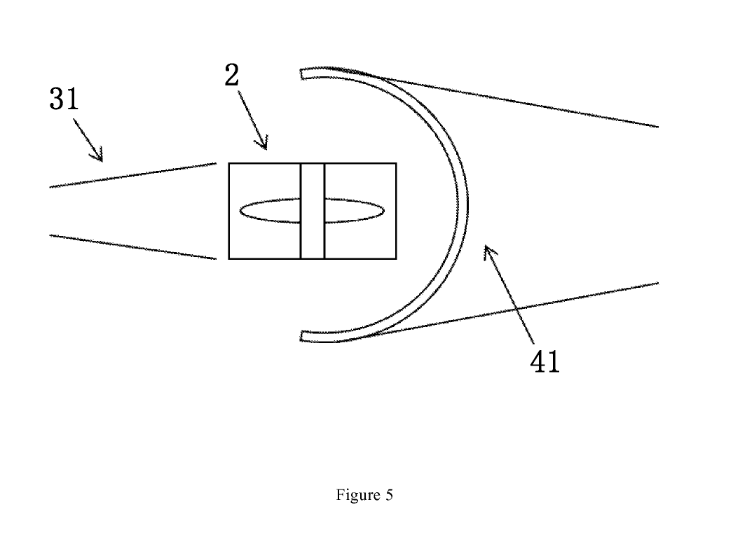

As shown in FIG. 4, an LCD panel cutting debris suction device comprises a collection cap 41 positioned behind the traveling direction of a cutting wheel 21, and an air spray head 31 positioned in front of the traveling direction of the cutting wheel 21. The cutting mechanism 2 also comprises a cutting wheel fixing device 22 for fixing the cutting wheel 21; the cutting wheel 21 is provided with a collection cap 41 connected with a suction device 4 behind the traveling direction of the cutting wheel 21, and an air spray head 31 connected with an air supply device 3 in front of the cutting wheel 21. The debris collection device for cutting mechanism comprises one or multiple collection caps 41 of different sizes; the collection caps 41 are replaceable in accordance with the movement limitation of the cutting wheel 21 or the space of the original cutting machine, and the application range of the cutting machine is expanded. The upper part of the debris collection device for cutting mechanism also comprises a fixing device 1 for fixing the cutting mechanism 2; and the fixing device 1 comprises a spray head fixer 11 for fixing the air spray head 31 and a collection cap fixer 12 for fixing the collection cap 41. The cutting mechanism 2, the air spray head 31 and the debris collection cap 41 are simultaneously fixed by the fixing device 1 so that the three equipments can move simultaneously, and the operation difficulty is simplified. The spray head fixer 11 and the collection cap fixer 12 can be horizontally moved on the fixing device 1, and the length of both the spray head fixer 11 and the collection cap fixer 12 can be adjusted. Thus, the relative height and the relative distance of the gas spray head 31, the collection cap 41 and the cutting wheel 21 can be adjusted, so as to adjust the sweeping effect and the glass debris collection range. The air suction capacity of the suction device 4 is more than the air discharge capacity of the air supply device 3 so that the phenomenon that debris cannot be completely cleared because of unsmooth airflow is avoided.

The horizontal positions of the air spray head 31 and the collection cap 41 are higher than the position of the lower edge of the cutting wheel 21, so that scratches caused by directly contacting the glass panel are avoided.

The cutting mechanism 2 also comprises an adsorption tube 42 capable of adsorbing glass debris, and the collection cap 41 is connected with the suction device 4 by the adsorption tube 42. Because of space limitation, the debris collection cap 41 is short and small; the time of airflow passing through the debris collection cap 41 is short, and the glass debris collection effect is limited; because the adsorption tube 42 is thin and long, and there is sufficient time for airflow to separate from debris in the adsorption tube 42, the glass debris collection capacity of the collection cap 41 is further increased. The collection cap is made of non-conductive material instead of conductive material such as metal, conductive plastic and the like; this minimize the risk of wire short circuit because of the additional friction-produced and collision-produced metal debris remaining on the workpiece surface. Groove(s) is arranged in the collection cap 41, and the groove can prevent the collected debris from falling onto the workpiece surface again because of self-weight and collision.

As shown in FIG. 5, an opening of the collection cap 41 opposite to the cutting wheel 21 is inwards concave, and the width of the opening is more than the thickness of the cutting mechanism 2; for example, the opening is made into a semicircular shape, etc. The opening has large width and is inwards concave, and covers part of the cutting wheel 21 of the cutting mechanism 2 or even the whole cutting wheel 21 of the cutting mechanism 2. Thus, the collection range of the collection cap 41 is expanded, and the glass debris is cleanly sucked to the maximum extent.

The cutting mechanism 2 also comprises a blow pipe 32. The air spray head 31 is connected with the air supply device 3 by the blow pipe 32. Thus, the air spray head 31 is made to be short and small, and the mobility of the device is increased. The horizontal positions of the air spray head 31 and the collection cap 41 are higher than the position of the lower edge of the cutting wheel 21 so that scratches caused by directly contacting the glass panel are avoided. The airflow speed of the air supply device 3 can be adjusted so as to adjust the jet airflow in accordance with the field use situation to achieve the preferable glass debris suction effect.

The present invention is provided with a collection cap 41 behind the traveling direction of the cutting wheel 21, and an air spray head 31 in front of the traveling direction of the cutting wheel 21; the air spray head 31 is connected with an air supply device 3, and the collection cap 41 is connected with a suction device 4. In the process of cutting glass of the cutting wheel 21, the air spray head 31 positioned in front of the cutting wheel 21 ejects blowing airflow; the blowing airflow blows the cutting debris in front of the cutting wheel 21 and on both sides of the cutting wheel 21 to the back part of the traveling direction of the cutting wheel 21; the collection cap 41 positioned behind the traveling direction of the cutting wheel 21 produces absorption airflow under the action of the suction device 4; and the absorption airflow carries the cutting debris behind the traveling direction of the cutting wheel 21 and the cutting debris blown by the blowing airflow to enter the collection cap 41 together. Thereafter, the cutting debris is separated from air in the collection cap 41, and the cutting debris is kept in the collection cap 41. Compared with the simple rear suction, the technical scheme of the present invention has the advantages that the cutting debris produced in all directions in the cutting process is collected, and the cutting debris is thoroughly cleared; compared with the water spray or mist spray cutting device, the technical scheme of the present invention has the advantages that the cleared cutting debris is collected in the collection cap 41 together instead of being left on the LCD panel; the problems such as LCD panel line scratches, terminal scratches, short circuit, broken circuit, etc. caused by glass debris are effectively reduced; the subsequent LCD panel cleaning time is saved; the subsequent cleaning process is even cancelled; the productivity is increased, and the production capability is expanded. In a word, the present invention can clear the debris produced in the LCD panel cutting process in time, and can reduce relevant defects such as line scratches, terminal scratches, short circuit, broken circuit, etc. which are generated because of debris. Thus, the product yield and quality can be improved; the time of the subsequent cleaning process can be reduced; and the purposes of reducing risk, improving product yield and saving production cost can be achieved.

The present invention is described in detail in accordance with the above contents with the specific preferred embodiments. However, this invention is not limited to the cutting mode of the cutting wheel, and is also applied to the cutting mode of directly using cutter heads (such as alloy cutter heads, diamond cutter heads and the like). Of course, the present invention is not limited to the field of LCD cutting, but is applied to other occasions on which debris is produced in the cutting process. For the ordinary technical personnel of the technical field of the present invention, on the premise of keeping the conception of the present invention, the technical personnel can also make simple deductions or replacements, and all of which should be considered to belong to the protection scope of the present invention.

We claim:

1, A debris collection device for cutting mechanism, comprising: a collection cap positioned behind the traveling direction of said cutting mechanism, and an air spray head positioned in front of the traveling direction of said cutting mechanism.

2, The debris collection device for cutting mechanism of claim 1, wherein groove(s) is arranged in said collection cap.

3, The debris collection device for cutting mechanism of claim 1, wherein an opening of said collection cap opposite to said cutting mechanism is inwards concave, and the width of the opening is more than the thickness of said cutting mechanism.

4, The debris collection device for cutting mechanism of claim 3, wherein said opening is semicircular in shape.

5, The debris collection device for cutting mechanism of claim 1, wherein said debris collection device for cutting mechanism comprises multiple collection caps of different sizes.

6, The debris collection device for cutting mechanism of claim 1, wherein said debris collection device for cutting mechanism also comprises an adsorption tube capable of adsorbing cutting debris, and said collection cap is connected with said suction device by said adsorption tube.

7, The debris collection device for cutting mechanism of claim 1, wherein said debris collection device for cutting mechanism also comprises a blow pipe, and said air spray head is connected with said air supply device by said blow pipe.

8, The debris collection device for cutting mechanism of claim 1, wherein said debris collection device for cutting mechanism also comprises a fixing device for fixing the cutting mechanism, and said fixing device comprises a spray head fixer for fixing said air spray head and a collection cap fixer for fixing said collection cap.

9, The debris collection device for cutting mechanism of claim 8, wherein said spray head fixer can be horizontally moved on said fixing device, and the length of said spray head fixer can be adjusted.

10, The debris collection device for cutting mechanism of claim 8, wherein said collection cap fixer can be horizontally moved on said fixing device, and the length of said collection cap fixer can be adjusted.

11, The debris collection device for cutting mechanism of claim 1, wherein the airflow speed of said air supply device can be adjusted.

12, The debris collection device for cutting mechanism of claim 1, wherein the air suction capacity of said suction device is more than the air discharge capacity of the air supply device.

13, The debris collection device for cutting mechanism of claim 1, wherein said cutting mechanism comprises a cutting wheel; said debris collection device for cutting mechanism is provided with a collection cap connected with the suction device behind the traveling direction of said cutting wheel, and is provided with an air spray head connected with the air supply device in front of the traveling direction of said cutting wheel.

14, The debris collection device for cutting mechanism of claim 13, wherein the horizontal positions of said air spray head and said collection cap are higher than the position of the lower edge of the cutting wheel.

15, The debris collection device for cutting mechanism of claim 13, wherein said collection cap is made of non-conductive material.

16, An LCD panel cutting debris suction device, comprising: a collection cap positioned behind the traveling direction of a cutting wheel of an LCD cutting mechanism, and an air spray head positioned in front of the traveling direction of said cutting wheel.
